(19) United States
(12) Patent Application Publication
(10) Pub. No.: US 2023/0256851 A1
(43) Pub. Date: Aug. 17, 2023

(54) ELECTRONIC DEVICE FOR DETERMINING THE ENVIRONMENTAL RISK OF A CHARGING CABLE AND A CHARGING CABLE

(71) Applicant: Vestel Elektronik Sanayi ve Ticaret A.S., Manisa (TR)

(72) Inventor: Erol OZEN, Manisa (TR)

(21) Appl. No.: 18/011,494

(22) PCT Filed: Jun. 19, 2020
(86) PCT No.: PCT/EP2020/067085

§ 371 Date: Dec. 19, 2022

(51) Int. Cl. B60L 53/60; B60L 53/18

(52) U.S. Cl. CPC B60L 53/60; B60L 53/18

(57) ABSTRACT

An electronic device for determining the environmental risk of a charging cable for electrically connecting an electric vehicle charger with an electric vehicle has a sensing unit (401), a processing unit (402) and a communication unit (403). For transmitting release signal, the sensing unit (401) detects at least two different types of parameters. The processing unit (402) processes the at least two different types of parameters for more accurate detection of the environmental risk. The communication unit transmits the release signal in response to the determination of the environmental risk status.

### TECHNICAL FIELD

The present invention disclosure relates to an electronic device for determining environmental risk of a charging cable for electrically connecting an electric vehicle charger with an electrical vehicle, and a charging cable.

### BACKGROUND

There are many developments in the field of electric vehicles, as the use of electric vehicles, especially electric cars, increases due to various reasons. Electric cars use electric motors for the propulsion as opposed to their predecessors which use combustion motors. Electric motors require electricity in order to operate, which is mainly provided in electric cars by using batteries to obtain mobility. The battery of an electric car stores electricity during charging, which the stored electricity is used to provide the propulsion required by the electric vehicle. The battery is charged from the devices called electric vehicle charger, or alternatively called EV charger, EV charging station, electric vehicle supply equipment (EVSE) and such.

The use of batteries in EV vehicles, known also as EV batteries, has also various challenges. Although most electric vehicles use lithium-ion batteries, which have relatively higher energy density, longer life span and higher power density than other regular type of batteries, they are still subject to limitation for these features. Providing acceptable propulsion power for an acceptable distance in order to compete with combustion engines for the purpose of transportation requires a good amount of efficiency. There are also other factors to consider for storing electricity, especially capacity/size, safety, durability, thermal breakdown and cost of the battery.

EV chargers are devices which supply electric energy for the recharging of the battery of the electric vehicles. They have certain differences from a regular power supply, mainly for the purpose of supplying relatively higher amount of energy in a relatively shorter time period for the EV batteries. Commonly used EV chargers may provide AC power and/or DC power in order to charge the EV batteries of the electric vehicles.

The electrical power supplied by an EV charger is transferred by a charging connector to the electric vehicle. The charging connector connects the EV charger with the electric vehicle electrically, while being capable of detaching from either the EV charger or the electric vehicle. For this reason, many security mechanisms are needed in order to prevent any potential accidents which may occur when charging a moving electric vehicle with high power electricity using the charging connector.

### SUMMARY

According to a first aspect of the present disclosure, there is provided an electronic device for determining the environmental risk of a charging cable for electrically connecting an electric vehicle charger with an electric vehicle, the electronic device comprising; a sensing unit for detecting at least two different types of parameters in relation to the charging cable; a processing unit for determining an environmental risk status of the charging cable in response to the detected at least two different types of parameters; a communication unit for transmitting a release signal in response to the determination of the environmental risk status.

In an example, the processing unit is configured to determine the environmental risk status by comparing each of the at least two different types of parameters in relation to the charging cable with the threshold of the respective type of parameters.

In an example, the electronic device comprises a receiving section for receiving a part of the charging cable.

In an example, the receiving section is substantially ring shaped.

In an example, the sensing unit comprises an elastomeric sensor for detecting the surface topography of a detected part of the charging cable.

In an example, the sensing unit comprises a tension sensor for detecting the tension of the charging cable.

In an example, the sensing unit comprises a current sensor, preferably a hall sensor, for detecting the current of the electricity flowing through the charging cable.

In an example, the sensing unit comprises a temperature sensor for detecting the surface temperature of the charging cable.

In an example, the processing unit is configured to create the release signal which comprises an identifier for a receiver which the release signal is intended to be transmitted.

In an example, the communication unit is an RFID module.

In an example, the electronic device comprises a power inducting unit for inducing power from the charging cable.

In a second aspect of the present disclosure, a charging cable is provided which comprises the electronic device.

In an example, the charging cable comprises a socket for maintaining the contact of the charging cable to the electric vehicle, and the socket is configured to break the contact of the charging cable to the electric vehicle in response to the release signal.

In an example, the charging cable is attached releasably to the socket and the socket is configured to break the contact by releasing the charging cable.

In an example, the charging cable comprises a confirmation line for carrying a confirmation signal indicating that the charging cable is connected properly and the electronic device for determining the environmental risk of the charging cable electrically connected to the confirmation line for supplying electrical voltage to the electronic device.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of an electric vehicle charging system;

FIG. 2 shows schematically an example of a cross section of a charging cable disclosed herein.

FIG. 3 shows schematically an example of a socket of a charging cable disclosed herein.

FIG. 4 shows schematically an example of an electronic device disclosed herein.

FIG. 5 shows schematically an example of an electronic device disclosed herein.

FIG. 6 shows schematically an example of a charging cable disclosed herein and an electric vehicle charging system comprising the charging cable.

### DETAILED DESCRIPTION

Electric vehicles and electric vehicle chargers are two emerging technologies at the moment as an alternative to the vehicles working with combustion engines. Although there have been electric vehicles used for transportation in the past, such as electric trains and trolley buses, these vehicles are supplied with fixed power lines which are located at their predetermined route, therefore they provide only very limited mobility. There is now resurgence for electric vehicles, mainly because of the importance of renewable energy, and it is now possible to obtain reasonable distances with improved batteries which are specifically designed for electric vehicles and relatively more efficient electric motors.

Such electric vehicles comprise a battery for providing energy to the electric motors of the vehicle for providing the propulsion. Electric energy is stored in the battery, which is charged using a charger. The chargers are usually supplied by the electrical power grid. The EV charger supplies electricity to the electric vehicle for charging the battery, usually when the electric vehicle is stationary. The electric vehicle is then disconnected from the EV charger before any motion occurs and the electricity required for providing propulsion is provided by the battery.

Electric vehicles most commonly comprise lithium-ion or lithium polymer batteries for storing the electricity, mainly for their relatively high energy density compared to their weight; thereby more electric energy being stored at a unit volume than other type of batteries. Although these types of batteries had been mainly developed for consumer electronics, they are commonly used in electric vehicles also for their long cycle life. When it comes to the electric vehicles, there are also other concerns such as safety, charging rate and environmental friendliness for the batteries.

Electric vehicle charging stations which supply electrical energy to the electric vehicle batteries use various heavy duty or special connectors that conform to various corresponding standards. The commonly used connectors of the EV chargers include Combined Charging System (CCS), CHAdeMO, AC Type 1, AC Type 2 connectors, Tesla Superchargers etc. Such connectors are generally provided according to the charging method of the EV charger, which may be AC Charging and/or DC Charging.

There are also efforts to standardize the EV charging process. The international standard for electric vehicle conductive charging system, IEC 61851-1, has defined various modes for charging the electric vehicle. Additionally the Society of Automotive Engineering defines the general physical, electrical, communication and performance requirements for the EV charging systems in North America, for example as part of standard SAE J1772. The provided method and electronic device in the present disclosure may be implemented with any standard for EV charging, with any charging stations, or with electrical vehicle, as long as the features of the claims are realized.

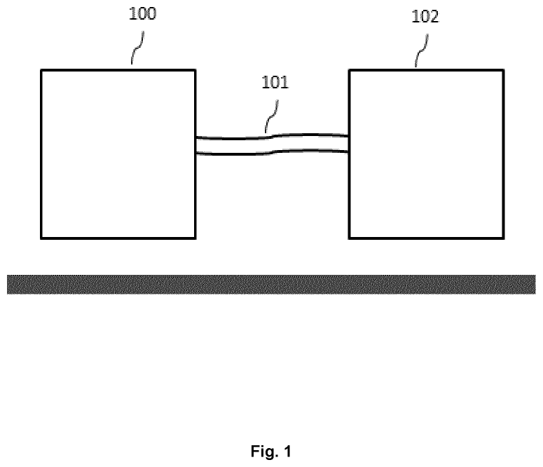

FIG. 1 shows an example of an electric vehicle charging environment for the present disclosure. An electric vehicle charger 100, supplies electrical energy via a charging cable 101 to the electric vehicle 102. As mentioned above, the electric vehicle charger 100 may be any electric vehicle charger, which is also called as EV charger, EV charging station, or electric vehicle supply equipment (EVSE). The EV charger 100 may supply AC current and/or DC current. The EV charger 100 may be a residential charging station, or a commercial charging station, or a fast charging station. The EV charger 100 may be compatible for any one of the known charging modes and/or charging levels. The EV charger 100 may comprise any type of plugs, i.e. a Type 1 plug, for example SAE J1772/2009 plug, a Type 2 plug, for example VDE-AR-E 2623-2-2 plug, a Type 3 plug, for example an EV Plug Alliance plug and/or a Type 4 plug, for example CHAdeMO plug, or a Combo 1 plug or a Combo 2 plug which are compatible to Combo 1 and Combo 2 connectors respectively. The EV charger 100 may have a plurality of the plugs above or combination of such plugs.

The electric vehicle 102 may be any electric vehicle which uses one or more electric motors or traction motors for propulsion. In one example, the electric vehicle 102 may have a battery for storing electrical energy. The electric vehicle 102 may be a road or a rail vehicle, or a water vehicle, or an underwater vehicle, or an electric aircraft or an electric spacecraft. The electric vehicle 102 may also be a hybrid vehicle, i.e. a vehicle which uses electricity and another source of energy, such as petroleum to provide propulsion. The electric motors of the electric vehicle 102 may be an AC motor, or a DC motor, or even a universal motor which may be compatible with AC current or DC current.

The charging cable 101 may be any charging cable which is suitable for transferring the electrical energy supplied by the EV charger 100 to the electric vehicle 102. In an example, the charging cable 101 includes a power socket which may be detachably connected with the plug of the EV charger. The power socket may be compatible with any one of the plug types of the EV charger, which include the ones mentioned above in this disclosure. The charging cable 101 also includes a vehicle socket which is suitable for detachably connecting with the electric vehicle 102 for transferring the electricity supplied by the EV charger 100 to the battery of the electric vehicle 102. The charging cable 101 may also include a circuit integrated for various purposes. In an example, the circuit is used for detecting excessive currents flowing through the charging cable.

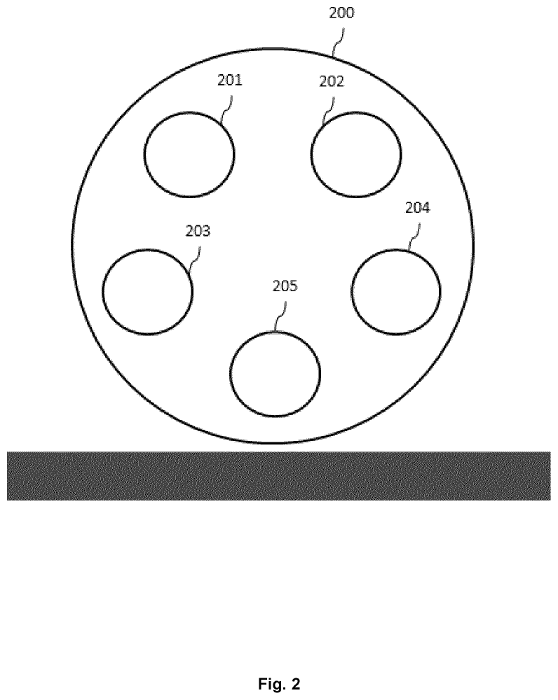

The cross section of an example of a charging cable is shown in FIG. 2. In this example, the charging cable 200 comprises five separate conducting lines, 201, 202, 203, 204, 205 which are suitable for carrying electric current supplied by an EV charger, and thereby electrically connecting the EV charger with the electric vehicle. The conducting lines, or conductors, are separated by insulating section, or an insulator. In an example, the conductor may be a solid wire. In another example, one of or each of the conductors may comprise multiple wires. In one example, one of or each of the conductors may comprise multiple wires which are twisted or braided together, to produce a larger wire.

The conductor may be any element having a reasonable conductance for transmitting electricity. In an example the conductor may comprise any material having good conductivity such as copper, or silver, or gold, or aluminium, or any alloy which has reasonable conductance for transmitting electricity.

In an example each of the conducting lines 201, 202, 203, 204, 205 may have various purposes and uses, and they match with a compatible socket. The charging cable 200 is suitable for a socket having at least five separate connectors. The socket of the charging cable 200 may comprise male connectors or female connectors. In an example the socket may comprise mixed-gender connectors. The connectors may be in the same size, or in another example at least two of the connectors may be in different sizes.

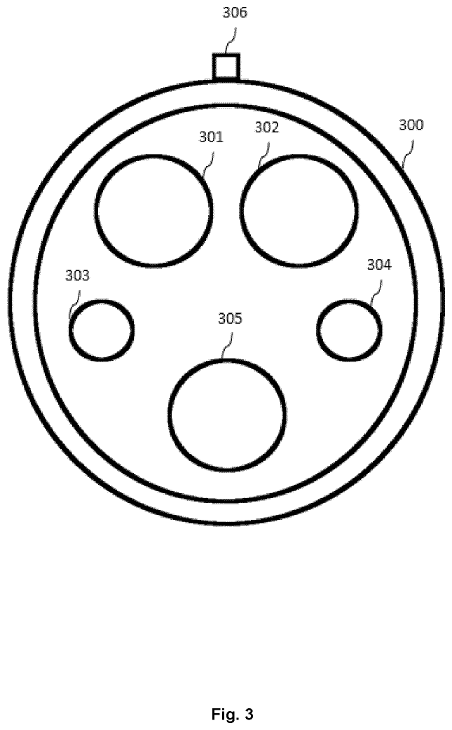

FIG. 3 shows a socket 300 which is compatible with the charging cable 200. The socket 300 has five separate connectors 301, 302, 303, 304, 305, wherein each of the connectors 301, 302, 303, 304, 305 are electrically connected with the respective conducting lines 201, 202, 203, 204, 205 of the charging cable. In an example, the socket 300 is arranged to contact the EV charger, when the charging cable 200 connects the EV charger with the electric vehicle. In an example the socket 300 is arranged to contact the electric vehicle, when the charging cable 200 connects the EV charger with the electric vehicle. In an example, the charging cable 200 comprises two sockets on both ends. In this example, the first socket is arranged to contact the electric vehicle and the second socket is arranged to contact the EV charger. In an example the socket 300 comprises a latch 306 for breaking the contact and releasing the charging cable

In an example, the conducting lines 201, 202, 203, 204, 205 and the respective connectors 301, 302, 303, 304, 305 are arranged, such that each of the respective conducting line and connector pair carries a different signal. The conducting line 201 and the conducting line 202 are arranged to carry the supply voltage supplied by the EV charger to the electric vehicle. They may be arranged to carry AC current, or DC current, or even both. The conducting line 203 is arranged to carry a signal from the EV charger to the electric vehicle for the purpose of preventing movement of the electric vehicle, while the electric vehicle is connected to the EV charger. The conducting line 204 is arranged to carry a signal indicating certain features related to the charging process. In one of the examples, the conducting line 204 is arranged to carry the signal indicating the charging level between the EV charger and the electric vehicle. In another example, the conducting line 204 may be arranged to carry the signal indicating the beginning of the charging process. The conducting line 205 is arranged to act as ground.

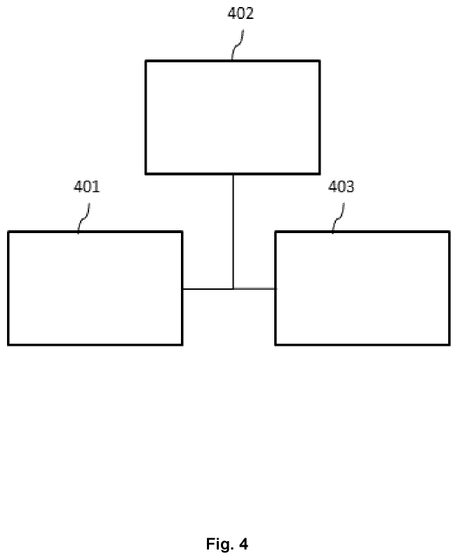

FIG. 4 shows schematically an example of an electronic device disclosed herein. The electronic device for determining environmental risk of a charging cable for electrically connecting an electrical vehicle charger with an electric vehicle comprises a sensing unit 401. The sensing unit 401 may be any sensing unit which is suitable for detecting at least two different types of parameters in relation to the charging cable.

In an example, the sensing unit 401 comprises at least two different types of sensors for detecting events or changes in their respective environment, and thereby detecting two different types of parameters. Each type of the sensors may be a MOS (metal-oxide-semiconductor) sensor, for measuring physical, chemical, biological or environmental parameters. In an example, at least one of types of the sensors may be an image sensor comprising a charge-coupled device (CCD) or a CMOS active-pixel sensor. In an example, at least one of the types of the sensors may be a monitoring sensor, which may include a house monitoring sensor, a traffic monitoring sensor, a weather monitoring sensor, a temperature monitoring sensor, a humidity monitoring sensor, an air pollution monitoring sensor, a fire sensor, a health sensor, a tension sensor, a gas sensor, an elastomeric sensor for detecting a surface topography or a current sensor such as a hall sensor.

In an example, one of the sensors of the sensing unit 401 may comprise an elastomeric sensor for detecting the surface topography of a part of the charging cable. The elastomeric sensor detects the surface topography for the purpose of measuring mechanical deformations of the charging cable, such as pressure, strain, shear and torsion. In an example, the elastomeric sensor comprises a sheet of transparent rubber material which is the one side of the transparent rubber material which is facing the part of the charging cable is coated with a metallic paint. The opposite side of the transparent rubber material comprises a camera and a plurality of lights having different colours. The camera is arranged to take a picture of the part of the charging cable through the transparent rubber material and the metallic paint for detecting the surface topography of the part of the charging cable.

In an example, one of the sensors of the sensing unit 401 may comprise a tension sensor for detecting the tension of the charging cable. In an example, the tension sensor detects the tension of the charging cable by measuring the deflection of a part of the charging cable. In another example, the tension sensor detects the tension of the charging cable by detecting the frequency of the vibration of the charging cable.

In an example, one of the sensors of the sensing unit 401 may comprise a current sensor for detecting the current of the electricity flowing through the charging cable. In an example, the current sensor may be any sensor which is capable of detecting the current of the electricity flowing through the charging cable without the need of contact. In an example, the current sensor comprises a Rogowski coil, or a flux gate sensor or a magneto-resistive current sensor. In an example the current sensor comprises a hall-effect sensor for detecting the current of the electricity flowing through the charging cable by detecting the magnetic field produced by the charging cable.

In an example, one of the sensors of the sensing unit 401 may comprise a temperature sensor for detecting the surface temperature of a part of the charging cable. In an example, the temperature sensor may comprise an NTC thermistor, or a resistance temperature detector, or a thermocouple.

The electronic device of the present disclosure comprises a processing unit 402. The processing unit 402 may be coupled to the sensing unit 401. The processing unit 402 is suitable for determining an environmental risk status of the charging cable in response to the detected at least two different types of parameters. The determined environmental risk status may any data indicating the environmental risk for the charging cable. In an example, the environmental risk status may be a Boolean indicating only two cases, i.e. safe and risky, or a percentage indicating the risk. In an example, the environmental risk status may indicate the kind of the environmental risk.

The electronic device of the present disclosure comprises a communication unit 403. The communication unit 403 may be coupled to the processing unit 402. The communication unit 403 is suitable for transmitting a signal. In an example, the communication unit 403 is suitable for transmitting a release signal in response to the determination of the environmental risk status. The communication unit 403 may be compatible with any communication method which is suitable for sending data. The communication unit 403 may comprise an antenna. In an example, the communication unit 403 may comprise an RFID transmitter. In an example, the communication unit 403 may comprise a Bluetooth transmitter, or a WLAN transmitter, or an IR transmitter, or a mobile communication transmitter, or a visible light transmitter. In an example, the communication unit 403 may comprise an RFID receiver, or a Bluetooth receiver, or a WLAN receiver, or an IR receiver, or a mobile communication receiver, or a visible light receiver.

The release signal may be created by the processing unit 402 for the communication unit 403, so that the communication unit 403 can send the release signal. In an example, the release signal may be a signal which by its presence indicates that the contact of the charging cable to the electric vehicle is to be broken. In an example, the release signal may comprise data indicating the risk detected by the electronic device for the purpose of another processing. In an example, the release signal may indicate what kind of environmental risk is detected by the electronic device.

In an example, the electronic device stores an identifier for the release signal to be sent. In an example the identifier may be any data which may identify the receiver which the release signal is transmitted for. In an example, the identifier may be a MAC address, or an IP address, or a name of the device, or any other identifier that is assigned for the receiver. In an example, the receiver, which the release signal is transmitted for, may be comprised by the electric vehicle. In an example, the receiver may be comprised by the EV charger. In an example, the receiver may be comprised by at least one of the sockets of the charging cable. In an example, the identifier may be stored in the memory during production of the charging cable, or alternatively the identifier may be obtained by some sort of a handshaking process with the electric vehicle or with the EV charger. In an example the release signal is broadcasted by the communication unit 403 when the release signal comprises the identifier, so that each device which is able to receive the broadcast can check the identifier provided with the release signal with its own identifier whether the release signal is directed to it.

In an example the electronic device also comprises a power inducting unit for inducing power from the charging cable. In an example, the power inducting unit comprises a power receiver for receiving the power transmitted by the charging cable via time-varying electromagnetic field. The power receiver may be a coil of wire which is arranged to receive a magnetic field, or a metal plate which is arranged to receive an electric field, or an antenna which is arranged to receive a radio wave, or a laser diode, which receives light. The corresponding transmitter may be comprised by the charging cable, and the electronic device is located accordingly relative to the charging cable in order to provide wireless power transfer between the charging cable and the electronic device. In an example, the transmitter comprised by the charging cable is coupled to the conducting line which is arranged to carry a signal from the EV charger to the electric vehicle for the purpose of preventing movement of the electric vehicle, while the electric vehicle is connected to the EV charger. So the power is transmitted only when the electric vehicle is connected to the EV charger, and only then the electronic device is activated.

In an example, the sensors of the sensing unit 401 continuously detect at least two different types of parameters in relation to the charging cable and they send the sensor readings of at least two different types of parameters to the processing unit 402. The processing unit 402 receives the sensor readings and process them in order to determine an environmental risk status of the charging cable.

In an example, a first sensor reading is obtained by a first sensor for detecting a first type of parameter in the sensing unit 401, and a second sensor reading is obtained by a second sensor for detecting a second type of parameter in the sensing unit 401. In an example, the first sensor is an elastomeric sensor and the second sensor is a tension sensor. In other examples, the first sensor and the second sensor may be combination of any known sensors, provided that they are from the different types. Although two sensors are mentioned in this example, this number is merely selected for illustrative purposes.

In an example, the electronic device comprises a memory for storing threshold values for each type of the sensors of the sensing unit 401. In an example, the threshold values may be predetermined during the production of the electronic device according to the type of the sensors and their risk. The processing unit 402 determines whether the first reading is above a first threshold which is the threshold value stored in the memory for the first sensor, and the processing unit 402 determines whether the second reading is above a second threshold which is the threshold value stored in the memory for the second sensor. If both the first reading and the second reading are above the respective thresholds, the processing unit 402 creates a release signal for transmitting with the communication unit 403. Accordingly environmental risk status is determined when each of the at least two different types of parameters are above the thresholds of the respective type of parameters.

In an example, the sensing unit 401 comprises a first sensor, a second sensor, and a third sensor, wherein each of them are different type of sensors. The processing unit 402 determines whether at least two of the readings are above their respective thresholds. For this purpose a first reading from the first sensor is compared with a first threshold and a second reading from the second sensor is compared with a second threshold and a third reading from the third sensor is compared with a third threshold. When at least two of the three comparisons are above the respective thresholds, the processing unit 402 creates a release signal for transmitting with the communication unit 403.

In an example, the release signal created by the processing unit 402 comprises an indication for which of the sensors are having above threshold readings. In an example, a table is stored in the memory of the electronic device, wherein the table indicates the type of the environmental risk according to the sensor readings. Just for the purpose of giving an example, the type of the environmental risk may be assigned as “MOVING CAR” indicating that the electric vehicle is moving, when one of the sensors is the elastomeric sensor and another one of the sensors is the tension sensor and their comparison with their respective thresholds are high. The processing unit identifies that only the elastomeric sensor reading and the tension sensor reading are above their respective thresholds, and determines an environmental risk status of the charging cable in response to the elastomeric sensor reading and the tension reading. The processing unit 402 creates the release signal according to the environmental risk status, such that the release signal comprises the indication that the electric vehicle is moving.

In an example, the sensing unit 401 comprises a tension sensor, a current sensor, a temperature sensor and an elastomeric sensor for detecting four different types of parameters in relation to the charging cable. The tension sensor may send its reading as a tension sensor reading. The current sensor may send its reading as a current sensor reading. The temperature sensor may send its reading as a temperature sensor reading. The elastomeric sensor may send its reading as an elastomeric sensor reading.

In this example, the processing unit 402 compares the tension sensor reading as a first type parameter with a tension threshold, the processing unit 402 compares the current sensor reading as a second type parameter with a current threshold, the processing unit 402 compares the temperature sensor reading as a third type parameter with a temperature threshold, and the processing unit 402 compares the elastomeric sensor reading as a fourth type parameter with an elastomeric threshold. The processing unit 402 determines an environmental risk status of the charging cable in response to the comparisons. In an example, the environmental risk status is determined in case at least two of the comparisons of different parameter types are above their respective thresholds.

The comparisons may be made conceptually. For example, the elastomeric sensor does not provide a single value as its reading, but it provides an image as its reading. The processing unit 402 may process the image, which is the reading of the elastomeric sensor. In an example, the processing unit 402 compares the read image with a threshold image. In another example, the processing unit 402 obtains a value by performing calculations and compares the calculated value from the read image with a threshold value. Any comparison with a reference, whether this reference is a value, or an array, or an image, or such, is considered a comparison with a threshold under the present disclosure.

In an example, the processing unit 402 reads the table indicating the type of the environmental risk according to the comparisons, and accordingly the environmental risk status. For example, if the tension reading and the elastomeric reading are high, the type of the environmental risk indicates that the electric vehicle may be moving. In an example, if the elastomeric reading and the temperature reading are high, the environmental risk indicates that the charging cable may be damaged by, for example, a corrosive material such as acid. In an example, if the current reading and the temperature reading are high, the environmental risk indicates that the charging cable may be ruptured only partially. So, the table comprises a plurality of sensor reading combinations and corresponding type of the environmental risks to the respective combinations.

In an example, the processing unit 402 creates the release signal according to the type of the environmental risk assigned according to at least two different types of parameters detected by the sensing unit 401. In an example, the release signal comprises an indication of the type of the environmental risk assigned according to at least two different types of parameters detected by the sensing unit 401.

In an example, the release signal comprises an identifier in relation to the type of the environmental risk. In an example, the table indicating the type of the environmental risk comprises the identifiers for a plurality of receivers which the release signal is intended to be transmitted for different cases of the plurality of sensor reading combinations. Accordingly, when a type of the environmental risk is determined by the processing unit 402, the processing unit 402 creates the release signal for transmitting the release signal to the corresponding receiver. In an example, the release signal comprises the identifier which corresponds to the sensor reading combination in the table. In one of the examples compliant above, when the type of the environmental risk is determined as the vehicle may be moving, the release signal is transmitted to the electric vehicle for stopping the vehicle; and alternatively when the type of the environmental risk is determined as the charging cable may be ruptured, the release signal is transmitted to the EV charger for instructing the operator to change the cable.

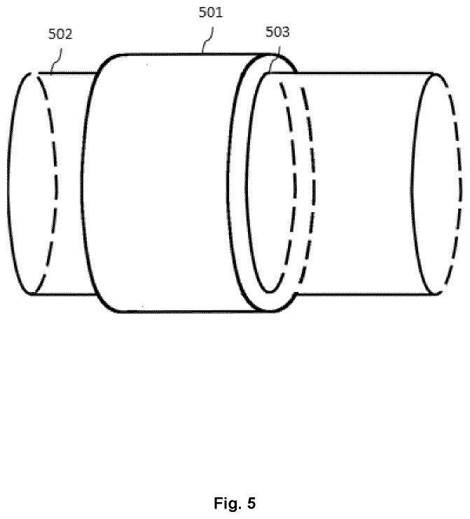

FIG. 5 shows schematically an example of an electronic device disclosed herein. In the example, the electronic device 501 encompasses a part of the charging cable 502. For this purpose, the electronic device 501 may comprise a receiving section 503 for receiving a part of the charging cable. Furthermore, the receiving section of the electronic device 501 may also be substantially ring shaped, so it can retain the charging cable by providing more contact points to the part of the charging cable 501 received by the receiving section 503 when the charging cable has a circular cross-section, for more accurate detection by the sensing unit.

In an example, the charging cable comprises at least one socket for maintaining the contact of the charging cable to the electric vehicle. The charging cable may comprise a power socket which is suitable for detachably connecting with the plug of the EV charger. The power socket may be compatible with any one of the plug types of the EV charger, which include the ones mentioned above in this disclosure. In an example, the charging cable may comprise a vehicle socket which is suitable for detachably connecting with the electric vehicle for transferring the electricity supplied by the EV charger to the battery of the electric vehicle.

In an example, at least one of the sockets may be configured to break the contact of the charging cable to the electric vehicle in response to the release signal. In an example the charging cable is attached releasably to the socket, so that the attachment of the charging cable to the socket is release in response to the release signal. In an example, the socket may be configured to break the contact of the charging cable to the electric vehicle by releasing the charging cable, while the socket is still plugged into the electric vehicle. In an example, the release is performed by opening the latch which is holding the charging cable with the socket against the gravity, thereby the charging cable falls under the effect of gravity. In an example, the release is performed by opening the latch which is holding the socket plugged into the electric vehicle, and the socket is arranged to be plugged out when the latch is opened.

In an example, the charging cable comprises a confirmation line for carrying a confirmation signal indicating that the charging cable is connected properly. In an example the electronic device is connected to the confirmation line for supplying electrical voltage to the electronic device. The connection may be provided via a direct cable connection, i.e. conducting line from the confirmation line to the electronic device for supplying the electrical energy required for the electronic device. In an example, the connection may be provided via wirelessly, via the transmitter of the charging cable for wireless power transfer as mentioned in previous sections.

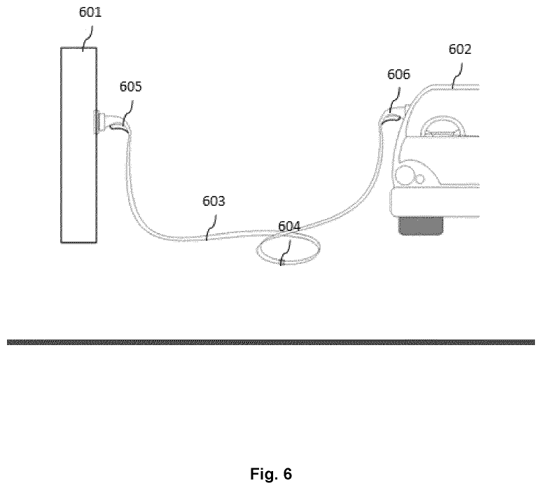

In FIG. 6, an example of an EV charging system is schematically shown which comprises an EV charger 601, an electric vehicle 602, a charging cable 603 comprising an electronic device 604 according to the present disclosure. The charging cable 603 is releasably attached to the power socket 605 and it is releasably attached to the vehicle socket 606.

In an example, a charging cable 603 is provided wherein the charging cable 603 comprises the electronic device 604 of the present disclosure. Any one of the examples which are explained in the present disclosure which are directed to the electronic device may also be applied to the charging cable 603 which comprises the electronic device 604. In this example, the electronic device 604 is provided as a part of the charging cable 603.

It will be understood that the processor referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to memory. This may be provided by a semiconductor memory, or single chip or integrated circuit or plural chips or integrated circuits, optionally provided as a chipset, or single device or by plural devices. Suitable devices include for example a RAM, DRAM, SRAM, a hard disk and non-volatile semiconductor memory (e.g. a solid-state drive or SSD).

The word “exemplary” or “example” is used herein to mean “serving as an example, instance, or illustration.” Any aspect or design described herein as “exemplary” or “example” is not necessarily to be construed as preferred or advantageous over some aspects or designs.

The words “plural” and “multiple” in the description and the claims expressly refer to a quantity greater than one. Accordingly, any phrases explicitly invoking the aforementioned words (e.g. “a plurality of [objects],” “multiple [objects]”) referring to a quantity of objects expressly refers more than one of the said objects. The terms “group (of),” “set [of],” “collection (of),” “series (of),” “sequence (of),” “grouping (of),” etc., and the like in the description and in the claims, if any, refer to a quantity equal to or greater than one, i.e. one or more. The terms “proper subset,” “reduced subset,” and “lesser subset” refer to a subset of a set that is not equal to the set, i.e. a subset of a set that contains less elements than the set.

1. Electronic device for determining the environmental risk of a charging cable for electrically connecting an electric vehicle charger with an electric vehicle, the electronic device comprising;
a sensing unit for detecting at least two different types of parameters in relation to the charging cable;
a processing unit for determining an environmental risk status of the charging cable in response to the detected at least two different types of parameters;
a communication unit for transmitting a release signal in response to the determination of the environmental risk status.

2. Electronic device for determining the environmental risk of a charging cable according to claim 1, wherein the processing unit is configured to determine the environmental risk status by comparing each of the at least two different types of parameters in relation to the charging cable with the threshold of the respective type of parameters.

3. Electronic device for determining the environmental risk of a charging cable according to claim 1, wherein the electronic device comprises a receiving section for receiving a part of the charging cable.

4. Electronic device for determining the environmental risk of a charging cable according to claim 3, wherein the receiving section is substantially ring shaped.

5. Electronic device for determining the environmental risk of a charging cable according to claim 1, wherein the sensing unit comprises an elastomeric sensor for detecting the surface topography of a detected part of the charging cable.

6. Electronic device for determining the environmental risk of a charging cable according to claim 1, wherein the sensing unit comprises a tension sensor for detecting the tension of the charging cable.

7. Electronic device for determining the environmental risk of a charging cable according to claim 1, wherein the sensing unit comprises a current sensor, preferably a hall sensor, for detecting the current of the electricity flowing through the charging cable.

8. Electronic device for determining the environmental risk of a charging cable according to claim 1, wherein the sensing unit comprises a temperature sensor for detecting the surface temperature of the charging cable.

9. Electronic device for determining the environmental risk of a charging cable according to claim 1, wherein the processing unit is configured to create the release signal which comprises an identifier for a receiver which the release signal is intended to be transmitted.

10. Electronic device for determining the environmental risk of a charging cable according to claim 1, wherein the communication unit is an RFID module.

11. Electronic device for determining the environmental risk of a charging cable according to claim 1, wherein the electronic device comprises a power inducting unit for inducing power from the charging cable.

12. A charging cable, wherein the charging cable comprises the electronic device for determining the environmental risk of the charging cable according to claim 1.

13. A charging cable according to claim 12, wherein the charging cable comprises a socket for maintaining the contact of the charging cable to the electric vehicle, and the socket is configured to break the contact of the charging cable to the electric vehicle in response to the release signal.

14. A charging cable according to claim 13, wherein the charging cable is attached releasably to the socket and the socket is configured to break the contact by releasing the charging cable.

15. A charging cable according to claim 12, wherein the charging cable comprises a confirmation line for carrying a confirmation signal indicating that the charging cable is connected properly and the electronic device for determining the environmental risk of the charging cable electrically connected to the confirmation line for supplying electrical voltage to the electronic device.
